(19) United States
(12) Patent Application Publication
(10) Pub. No.: US 2010/0015265 A1
(43) Pub. Date: Jan. 21, 2010

(54) PRESSURE BLADDER AND METHOD FOR FABRICATION

(75) Inventor: John H. Vontell, Manchester, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 12/220,031

(22) Filed: Jul. 21, 2008

(51) Int. Cl. B29D 22/02

(52) U.S. Cl. 425/53; 156/245

(57) ABSTRACT

A pressure bladder has a seamless shell made from an elastomeric material, an inner cavity, and a pressure port. The bladder can also have a reinforcement layer and an outer layer to reinforce the bladder and define the bladder's outer dimensions and pressure profile. In order to fabricate the bladder, a mandrel is formed, and the pressure port is positioned on the surface of the mandrel. The mandrel is then coated with the elastomeric material and placed in a mold. A reinforcement layer is added and an elastomeric material is injected into the mold to form the outer layer. The mandrel is then removed from the mandrel assembly by applying heat and pressure to the bladder such that the mandrel can be extracted through the pressure port.

### STATEMENT OF GOVERNMENT INTEREST

The U.S. Government has a paid-up license in this invention and the right in limited circumstances to require the patent owner to license others on reasonable terms as provided for by the terms of N00019-02-C-3003 awarded by the United States Navy.

### BACKGROUND

This invention relates to bladders used to apply pressure to composite materials that are bonded together with an adhesive to make gas turbine components. Mechanical tooling, such as clamps and other fixturing devices, are often used to apply pressure to composite materials in order to cure an adhesive under desired conditions. In some applications, this curing process sometimes requires applying a specific, known pressure to the composite materials. The actual pressure transferred by the mechanical tooling to the component may be reduced by mechanical friction. Because the friction amount may vary, it is difficult to accurately compensate for the friction when calibrating the tooling. Even if the tooling is properly calibrated, the tooling often needs to be re-calibrated, particularly when subjected to thermal or pressure cycling. The maximum pressure that can be applied to a component with mechanical tooling, such as screw clamps, may be limited because thermal or pressure cycling may cause thread galling of the screw or other damage, causing the clamp to need frequent maintenance and replacement.

As a result of these disadvantages, bladders can be preferable as pressure applicators because they are capable of applying a controlled amount of pressure to a component. Bladders are typically formed about a mandrel in at least two portions such that the bladder can be removed from the mandrel or vice versa. The mandrel can then be reused to make another bladder. The fabrication process of secondarily bonding the bladder segments causes seams and other structural defects in the bladder. These seams and structural defects can have a negative effect on the structural integrity of the bladder. Therefore, bladders may be prone to damage due to thermal or pressure cycling because of weak points within the structure of the bladder. Such structural failures may require early replacement of the bladder.

### BRIEF SUMMARY OF THE INVENTION

The present invention is a seamless pressure bladder having a seamless shell made from a first layer of an elastomeric material. The seamless shell defines an inner cavity having a desired shape. A pressure port is incorporated into the seamless shell for filling the inner cavity with a gas or liquid to increase the pressure in the bladder, and the pressure is applied with the pressure face on the outside of the seamless shell.

In some embodiments, in order to reinforce the seamless shell, inserts are added to the outer surface of the first layer. The inserts can be made from additional cured elastomer, cured reinforced elastomer, structural polymer, thermoplastic, ceramic, or metal. An outer layer covers the inserts. The inserts and the outer layer allow for the outer dimensions of the bladder and the bladder's pressure profile to meet parameters desirable for applying pressure to bond gas turbine components bonded with an adhesive.

In order to fabricate the bladder, a mandrel is formed and the pressure port is positioned on the surface of the mandrel. An elastomeric material is then applied to the outer surface of the mandrel, forming a mandrel assembly. The mandrel assembly is then placed into a mold. The inserts used in the reinforcement layer are placed on the outer surface of the mandrel assembly, and an elastomeric material is injected into the mold to form the outer layer. The mandrel is then removed from the mandrel assembly by applying heat and pressure to the bladder such that the mandrel becomes a liquid or a vapor that can be extracted through the pressure port.

### BRIEF DESCRIPTION OF THE DRAWINGS

FIG. 1 is a cross-sectional view of a first embodiment of the bladder.

FIG. 2A is a cross-sectional view of the mold used to form the mandrel.

FIG. 2B is a cross-sectional view of the mold as its being filled with a material to form the bladder.

FIG. 2C is a cross-sectional view of the mandrel and a pressure port.

FIG. 2D is a cross-sectional view of the mandrel after it has been coated with an elastomeric material.

FIG. 2E is a cross-sectional view of the coated mandrel placed inside a mold to form the outer surface of the bladder.

FIG. 2F is a cross-sectional view of the bladder as the mandrel is being removed from the bladder.

FIG. 3 is a cross-sectional view of a second embodiment of the bladder.

FIG. 4 is a cross-sectional view of a third embodiment of the bladder.

FIG. 5 is a cross-sectional view of the mandrel placed inside a mold to form the third embodiment of the bladder.

FIG. 6 is a cross-sectional view of a fourth embodiment of the bladder.

FIG. 6A is a cross-sectional view of the mandrel after it has been coated with a material to form the fourth embodiment of the bladder.

### DETAILED DESCRIPTION

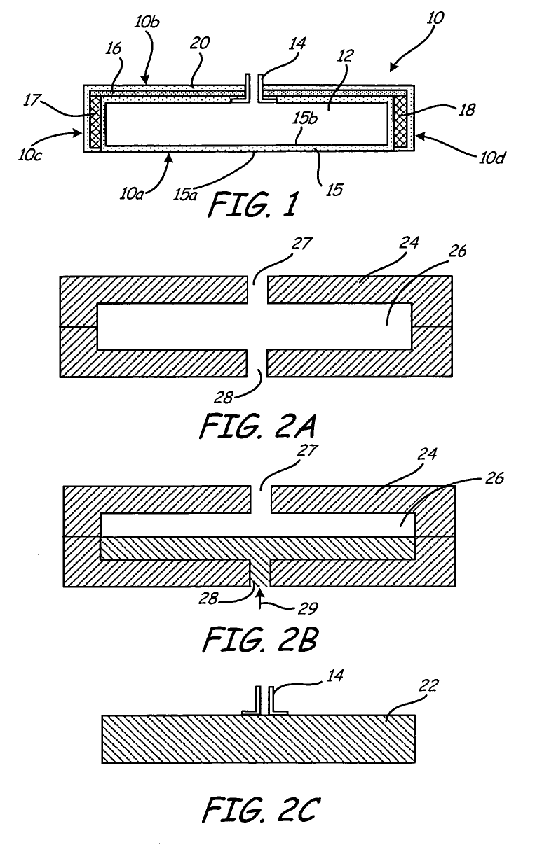

FIG. 1 shows a bladder 10 having a front wall 10a, a back wall 10b, and side walls 10c, 10d. Bladder 10 also has an inner cavity 12, a pressure face 13, and a pressure port 14. A first layer 15 is made from an elastomeric material and has an exterior surface 15a and an interior surface 15b. Interior surface 15b defines inner cavity 12, and exterior surface 15b defines pressure face 13. Pressure face 13 is, in this embodiment, front wall 10a. Bladder 10 as shown has inserts 16, 17, 18 and an outer layer 20. Inserts 16, 17, 18 may be made from additional cured elastomers, cured reinforced elastomers, structural polymers, thermoplastic, ceramics, or metals. A purpose of inserts 16, 17, 18 is to reinforce bladder 10. Outer layer 20 is made from an elastomeric material and is also used to reinforce bladder 10.

Bladder 10 can be easily customized to meet a desired pressure profile for the application of pressure to an article, such as a gas turbine component, which is useful for adhesive curing applications. Bladder 10 is capable of accurately applying a maximum pressure between about 0 N/mm² (0 psi) and 1.38 N/mm² (200 psi) to the gas turbine component surface, preferably between about 0.345 N/mm² (50 psi) and 1.38 N/mm² (200 psi). However, Bladder 10 could apply more than 1.38 N/mm² (200 psi), but this may affect the life of bladder 10. Bladder 10 can operate at temperatures between about −17.8° C. (0° F.) and 232° C. (450° F.), preferably between room temperature (about 22° C. (72° F.)) and about 148° C. (350° F.), but could operate at temperatures greater than 232° C. (450° F.) with a limited life.

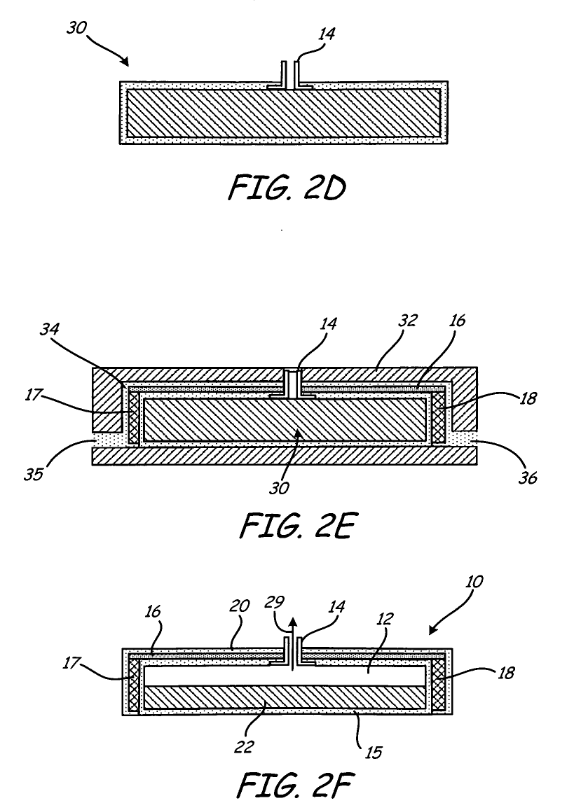

In order to form bladder 10, a mandrel 22 is formed using mechanical machining, casting, or transfer molding techniques. Although any of these techniques would achieve the desired results, as shown in FIG. 2A, mandrel 22 is formed using a mold 24, which has an injection cavity 26 and openings 27, 28 that can be used for injecting material into the injection cavity 26 or for venting purposes. Mold 24 can be made out of steel or other similar materials capable of supporting this molding technique. Injection cavity 26 is shaped in the desired shape of the inner cavity 12 of bladder 10. Referring to FIG. 2B, the injection cavity 26 is filled with a material 29 such that mandrel 22 (formed of the material 29) will generally have the following properties: dimensionally and chemically stable, capable of being handled at room conditions, and capable of being melted or vaporized. Material 29 can be a polymer, for example a polyethylene glycol material, such as Carbowax® (available from Union Carbide Corp.); a low melting temperature metal alloy having a melting temperature of less than about 260° C. (500° F.) and preferably less than about 204° C. (400° F.); or another suitable material. Once material 29 has solidified inside injection cavity 26 of mold 24 to form mandrel 22, mandrel 22 is removed from mold 24, and any excess material 29 can be removed from mandrel 22 by sanding or other common material removal techniques.

FIG. 2C shows the mandrel 22 with pressure port 14 positioned on the outside of mandrel 22. Pressure port 14 may be attached to the mandrel 22. Pressure port 14 is made from aluminum, stainless steel, or another material that can be adhered to the material used to make bladder 10 using elastomeric bonding techniques, such that the pressure port 14 is incorporated into bladder 10.

First layer 15 is formed about mandrel 22 and pressure port 14 as shown in FIG. 2D. Bladder 10 is made from an elastomeric material such as silicone that is coated onto mandrel 22. The elastomeric material can be applied to mandrel 22 by dipping, brushing, spraying or other similar techniques that would make a substantially uniform layer of material on mandrel 22. The mandrel 22 and bladder 10 can be handled by the pressure port 14 during application of the elastomeric material. Solvents compatible with the elastomeric material and mandrel may also be used. Additional layers of elastomeric material can be applied in order increase the thickness of first layer 15. A preferred thickness of first layer 15 is in the range of about 0.050 mm (0.002 inches) to 0.254 mm (0.010 inches), depending on the type of elastomeric material used. Once sufficiently cured, first layer 15 can be handled without tearing or puncturing during additional process steps. First layer 15, mandrel 22, and pressure port 14 collectively form mandrel assembly 30.

In FIG. 2E, mandrel assembly 30 is placed into another mold 32 that will be used to define the outer surface of bladder 10 and the pressure application profile of bladder 10. Mandrel assembly 30 is placed inside mold 32 having an injection cavity 34 and openings 35, 36 for injection and venting purposes. Mold 32 can be made out of any material capable of supporting this molding technique, preferably steel, and injection cavity 34 can have any shape, including complex shapes. One or more inserts 16, 17, 18 are added for molding the outer surface of bladder 10 and the pressure application profile. Inserts 16, 17, 18 can be placed on the outer surface of first layer 15. In one embodiment as shown in FIG. 2E, a top insert 16 can be placed on the top surface of mandrel assembly 30 and made from a metal. Side inserts 17 and 18 made from a reinforced elastomer can be placed on the side surfaces of mandrel assembly 30 to give structural support to bladder 10. Then the elastomeric material can be injected into the injection cavity 34 to make outer layer 20, which covers inserts 16, 17, 18 and defines the outer surface of bladder 10.

As shown in FIG. 2F, the mandrel 22 can be removed from bladder 10. For instance, using equipment capable of thermal vaporization such as a vacuum oven, heat and vacuum pressure removes the mandrel material 29 out of the bladder through pressure port 14. The removal of the mandrel material leaves inner cavity 12. Mandrel 22 can alternatively be removed by melting material 29, using solvent dissolution, or other means that keep bladder 10 seamless and substantially defect free. In an alternative embodiment, some or all of the material 29 of the mandrel 22 can remain inside the bladder 10, with fluid introduced though the pressure port 14 causing the bladder 10 to inflate around the mandrel 22.

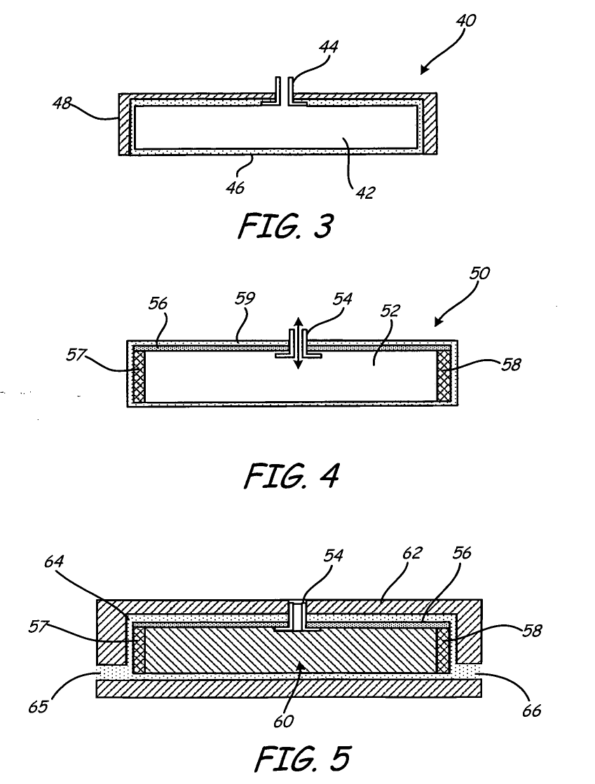

In an alternative embodiment shown in FIG. 3, a bladder 40 has an inner cavity 42, a pressure port 44, a first layer 46, and an outer layer 48. The process for creating bladder 40 is the same as shown in FIGS. 2A-2G, except that no inserts are used in making bladder 40. In further embodiments, the bladder can include material of a mandrel (not shown) in the inner cavity 42.

In another embodiment as shown in FIG. 4, a bladder 50 has an inner cavity 52; a pressure port 54; inserts 56, 57, 58; and an outer layer 59. To make bladder 50, a mandrel 60 is formed by a manufacturing method such as the methods shown in FIGS. 2A and 2B. As shown in FIG. 5, mandrel 60 is placed in a mold 62. Pressure port 54 and inserts 56, 57, 58 are positioned on mandrel 60. Mold 62 has an injection cavity 64 and openings 65, 66 for injection and venting purposes. Injection cavity 64 is filled with an elastomeric material to form outer layer 59 of bladder 50. Mandrel 60 can then be removed by the same process as shown by FIG. 2F, or left in place. Inserts 56, 57, 58 remain within the bladder 50 or are incorporated into outer layer 59 after mandrel 60 is removed such that inserts 56, 57, 58 do not puncture or otherwise damage outer layer 59.

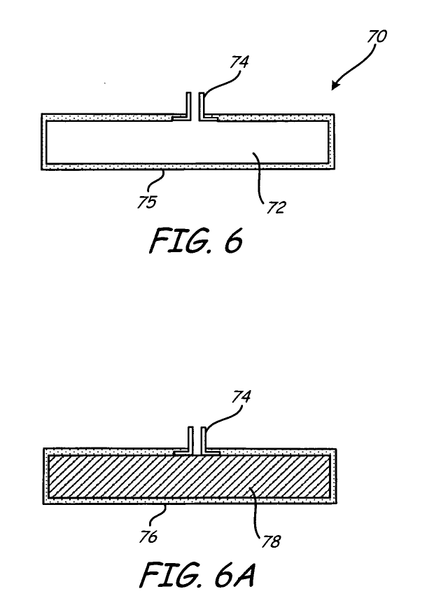

In the simplest embodiment, a bladder 70 as shown in FIG. 6 has an inner cavity 72, a pressure port 74, and a first layer 76. Mandrel 78 is made using the process shown in FIGS. 2A and 2B. Bladder 70 is formed as shown in FIG. 6A where mandrel 78 has been coated with an elastomeric material to form first layer 76. Mandrel 78 can then be removed by applying heat and pressure similar to the process shown by FIG. 2F, or left in place.

The present invention provides a seamless pressure bladder having a seamless shell comprising an elastomeric material that defines an inner cavity. A pressure port incorporated into the seamless shell permits adding fluid to and/or removing fluid from the inner cavity in order to control the pressure in the bladder. Fluid pressure in the bladder can be applied with the pressure face on the outside of the seamless shell. The bladder can be placed against a surface and suitably inflated in order to apply pressure to that surface. Such operation is useful in curing adhesives while regulating applied pressure in order to reduce a risk of damage to items bonded with the adhesive.

Although the present invention has been described with reference to preferred embodiments, workers skilled in the art will recognize that changes may be made in form and detail without departing from the spirit and scope of the invention.

1. A pressure bladder comprising:
a seamless shell having an exterior surface and an interior surface, wherein the seamless shell comprises an elastomeric material;
an inner cavity having a desired shape defined by the interior surface of the seamless shell;
a pressure face on the exterior surface of the seamless shell; and
a port in communication with the inner cavity and extending through a wall of the seamless shell.

2. The pressure bladder of claim 1 wherein the seamless shell has a front wall, a back wall, and side walls.

3. The pressure bladder of claim 2 wherein at least one of the front wall, back wall, and side walls has a reinforcement layer.

4. The pressure bladder of claim 3 wherein the reinforcement layer is made from a material selected from the group consisting of elastomers, polymers, thermoplastics, ceramics, metals and combinations thereof.

5. The pressure bladder of claim 2 wherein the pressure face is the front wall.

6. The pressure bladder of claim 1 wherein the pressure face is capable of applying a pressure of between about 0.690 N/mm² (100 psi) and 1.38 N/mm² (200 psi).

7. The pressure bladder of claim 1 wherein the bladder is operable at temperatures in a range of about 22° C. (72° F.) to about 148° C. (350° F.).

8. The pressure bladder of claim 1 further comprising:
an outer layer of an elastomeric material.

9. The pressure bladder of claim 8 further comprising:
a reinforcement layer between the seamless shell and the outer layer.

10. A method comprising:
forming a mandrel;
positioning a port adjacent an outer surface of the mandrel;
applying a first layer of an elastomeric material to the outer surface of the mandrel, the first layer having an inner surface, an outer surface, and a desired thickness;
allowing the first layer to cure at least partially; and
removing the mandrel from inside the first layer through the port to form a bladder.

11. The method of claim 10 wherein the port is attached to the outer surface of the mandrel.

12. The method of claim 10 wherein the elastomeric material adheres to the pressure port material.

13. The method of claim 10 wherein forming a mandrel comprises molding a mandrel material into a desired shape.

14. The method of claim 13 wherein the mandrel material is a polymer.

15. The method of claim 14 wherein the mandrel material is a polyethylene glycol.

16. The method of claim 13 wherein the mandrel material is a metal alloy having a melting point of less than about 500° F. (260° C.).

17. The method of claim 13 wherein removing the mandrel comprises heating the mandrel such that the mandrel material can be extracted from the first layer through the port to create an inner cavity.

18. The method of claim 17 wherein the mandrel is heated above a melting temperature of the mandrel.

19. The method of claim 18 wherein the mandrel is heated below a melting temperature of the first layer.

20. The method of claim 13 wherein removing the mandrel comprises dissolving the mandrel.

21. The method of claim 10 further comprising:
positioning the mandrel into a mold; and
introducing material into the mold to form an overlayer that covers at least a portion of the first layer before removing the mandrel from the bladder.

22. The method of claim 11 further comprising:
positioning at least one insert adjacent the outer surface of the first layer before forming the overlayer.

23. A method comprising:
forming a mandrel shaped to define an inner chamber of a bladder;
placing a port adjacent an outer surface of the mandrel;
positioning at least one insert adjacent the outer surface of the mandrel;
coating the mandrel and the at least one insert with an elastomer to create an elastomeric surface having a desired outer boundary; and
removing the mandrel through the port by applying heat and pressure.

24. The method of claim 23 wherein a mold forms the desired outer boundary of the elastomeric surface.

25. The method of claim 23 wherein the mandrel is made from a polymer.

26. The method of claim 23 wherein the mandrel is made from a low melting temperature metal alloy.

27. The method of claim 23 wherein the inserts are made from a material selected from the group consisting of elastomers, polymers, thermoplastics, ceramics, metals and combinations thereof.

28. A method comprising:
forming a first structure with a first material wherein the first structure has an outer surface;
adding a port on the outer surface of the mandrel;
covering the first structure with a second material to create a second structure wherein the port is integrated into the second structure having an outer surface and an inner surface; and
removing the first structure through the port to form a seamless pressure bladder.

29. The method of claim 28 wherein the outer surface of the first structure has a desired shape.

30. The method of claim 29 wherein at least one insert structure is placed onto the outer surface of the second structure.

31. The method of claim 30 wherein a third material covers the second structure and the at least one insert structure.

32. The method of claim 31 wherein a molding apparatus is used to mold the third material into a desired shape.

33. The method of claim 30 wherein the at least one insert structure is adhered to the outer surface of the second structure.

34. The method of claim 28 wherein removing the first structure comprises causing the first structure to change from a solid state to a fluid state.
